(19) United States
(12) Patent Application Publication
(10) Pub. No.: US 2014/0196285 A1
(43) Pub. Date: Jul. 17, 2014

(54) HEAT SIPHON HEAT COLUMN AND METHOD FOR MAKING THE SAME

(71) Applicant: NTIS ENTERPRISE CO., LTD., Taichung City (TW)

(72) Inventors: Chien-Shun Chao, Taichung City (TW); Tsan-Wen Chuang, Taichung City (TW); Chun-Hsiang Chan, Taichung City (TW); Shih-Chih Liu, Taichung City (TW); Chun-Nan Liu, Taichung City (TW)

(73) Assignee: NTIS ENTERPRISE CO., LTD., Taichung City (TW)

(21) Appl. No.: 13/738,996

(22) Filed: Jan. 11, 2013

(51) Int. Cl. B23P 15/26

(52) U.S. Cl. CPC B23P 15/26
USPC 29/890.03

(57) ABSTRACT

A method for making a heat column includes a step of preparing a section of a metal object; a step of forging the section of the metal object to be a hollow column which has a flat bottom, a guide surface being formed in the inner periphery of the hollow column, the hollow column having a flat bottom which has a heat-exchange surface; a step of making a neck on one end of the hollow column, and a step of sealing the neck by way of welding when the interior of the hollow column is sucked to be substantial vacuum status, liquid high heat transmission agent being introduced into the interior of the hollow column. The flat bottom is integral formed when the hollow column is formed and the flat bottom is in contact with the heat source.

### BACKGROUND OF THE INVENTION

(1) Field of the Invention

The present invention relates to a heat siphon heat column, and more particularly, to a method for making the heat siphon heat column with a flat bottom, a guide surface and a heat-exchange surface.

(2) Description of the Prior Art

The conventional heat columns such as the low-temperature heat column or normal temperature heat column are generally made by Copper, Aluminum or other metallic material. High heat transmission agents in the form of powders or liquid such as the Yttrium and Barium powders for the high temperature heat columns, or other high efficiency thermal conducting agents such as Ammonia for the middle temperature heat columns are introduced in the heat columns. When the molecular of the agent is heated, the agent is vaporized, and the agent is condensed and flows back when the heat column is cooled down. By this way, the heat source transmits the thermal energy in the form of waves whose speed is tens times higher than that of the metallic rods or fins. The heat column with this specific that of the metallic rods or fins. The heat column with this specific character is used to quickly remove heat from object that generates heat.

FIG. 1 shows the conventional heat column 1 and has a substantial vacuum interior. High heat transmission agent 2 is introduced in the heat column 1 so that when the agent 2 is heated, the agent is vaporized, the agent is condensed at the condensation section of the heat column 1. These steps are repeatedly executed to remove heat quickly. The tube-like heat column 1 is restricted by its limited surface or volume, the speed for removing heat is high, but the amount of heat that is removed is limited. Besides, the processes for making the heat column 1 are complicated so that the manufacturing of the conventional heat column 1 is not convenient.

As shown in FIG. 2, the two ends of the heat column 4 are sealed by two caps 5 which make the manufacturing processes be prolonged.

FIG. 3 shows another conventional heat column 6 which has to be made with a flatted end so as to be fully in contact with the surface 7 of the heat source to get better heat transmission feature. The surface 7 needs to be machined by extra punching processes.

FIG. 4 shows the two ends 9 of the heat column 8 are sealed by way of welding. Liquid high heat transmission agent 2 is introduced in the heat column 1 when the interior of the heat column 8 is vacuum, and the two ends 9 are sealed by way of welding. The welding processes for the two ends 9 require double the time for sealing only one end of other heat column.

The present invention intends to provide a heat column which improves the shortcomings of the conventional heat columns.

### SUMMARY OF THE INVENTION

The present invention relates to a method for making a heat column and comprises the follows steps:

preparing: preparing a section of a metal object which is cut from a metallic rod;

forging: forging the section of the metal object to be a hollow column which has a flat bottom, a guide surface being formed in the inner periphery of the hollow column, the hollow column having a flat bottom which has a heat-exchange surface;

necking: making a neck on one end of the hollow column, and

sealing: sealing the neck by way of welding when the interior of the hollow column is sucked to be substantial vacuum status, liquid high heat transmission agent being introduced into the interior of the hollow column.

The flat bottom is integral formed when the hollow column is formed and the flat bottom is in contact with the heat source.

The primary object of the present invention is to provide a method for making a heat column which is formed by way of forging and the flat bottom is integrally formed so as to be in contact with the surface of the heat source.

Another object of the present invention is to provide a method for making a heat column which has a guide surface integrally formed in the inner periphery of the hollow column to quickly circulate the liquid high heat transmission agent.

Yet another object of the present invention is to provide a method for making a heat column wherein the flat bottom has a heat-exchange surface to increase the efficiency of heat exchange.

A further object of the present invention is to provide a method for making a heat column wherein only one end of the hollow column needs to be sealed so as to reduce the manufacturing time and processes.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a cross sectional view to show the conventional heat column;

FIG. 2 is a plan view of the conventional heat column;

FIG. 3 shows the conventional heat column is flattened to have the surface to be in contact with heat source;

FIG. 4 shows that the conventional heat column is sealed on two ends thereof;

FIG. 5 shows the metal object to be made the heat column of the present invention;

FIG. 6 shows the hollow column of the heat column of the present invention;

FIG. 7 shows the guide surface in the inner periphery of the hollow column of the heat column of the present invention;

FIG. 8 is an enlarged view to show the guide surface of the hollow column of the heat column of the present invention;

FIG. 9 shows the heat-exchange surface of the bottom of the hollow column of the heat column of the present invention;

FIG. 10 shows that the heat-exchange surface is formed on the bottom of the hollow column of the heat column of the present invention;

FIG. 11 shows the neck of the hollow column of the heat column of the present invention;

FIG. 12 shows the sealing of the hollow column of the heat column of the present invention, and

FIG. 13 shows the heat column of the present invention.

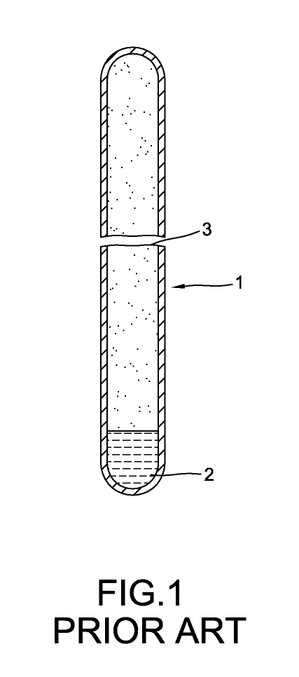

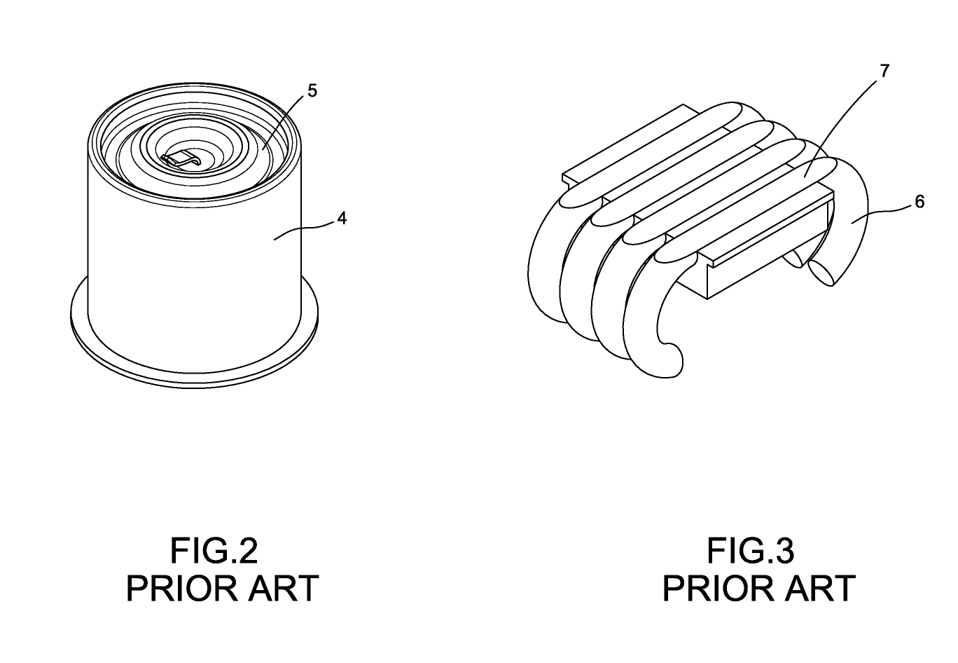

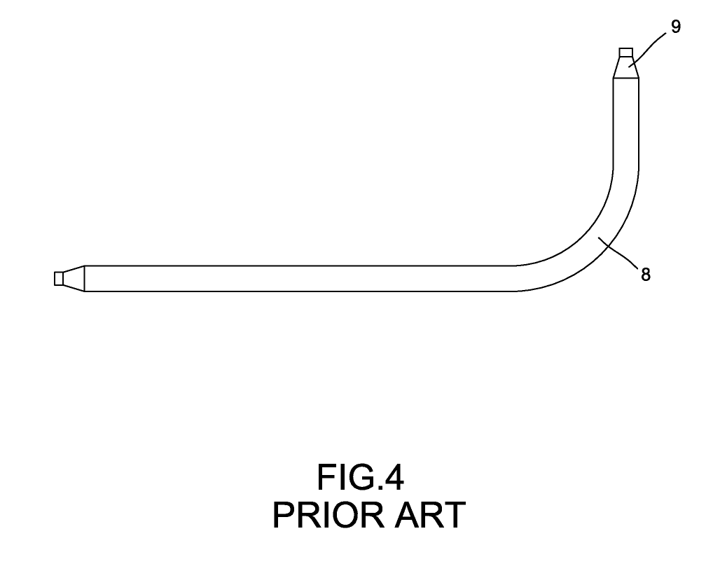

### DETAILED DESCRIPTION OF THE PREFERRED EMBODIMENT

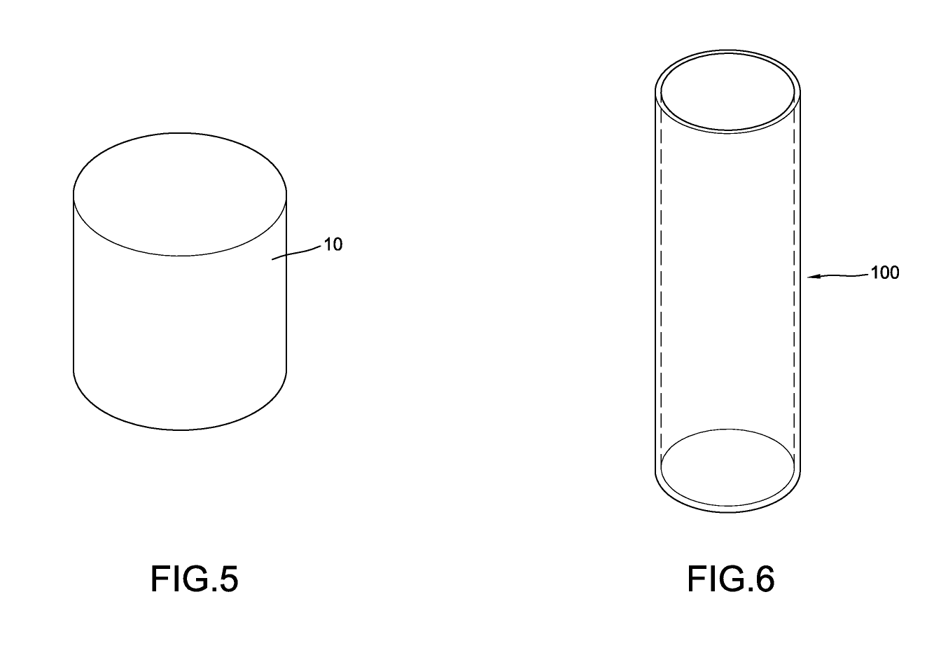

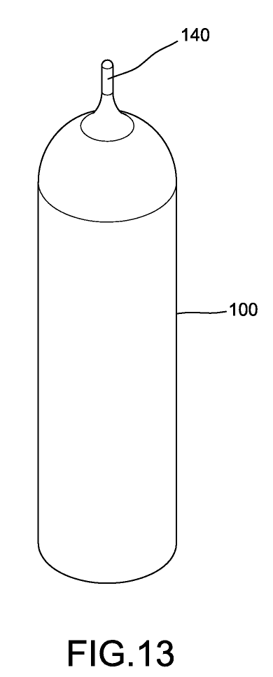

Referring to FIGS. 5 to 13, the method for making heat column of the present invention comprises the following steps:

Step of preparing: preparing a section of a metal object 10 as shown in FIG. 5. The metal object 10 is cut from a metallic and cylindrical rod and the metal object 10 is a cylindrical object which is a copper object or aluminum object.

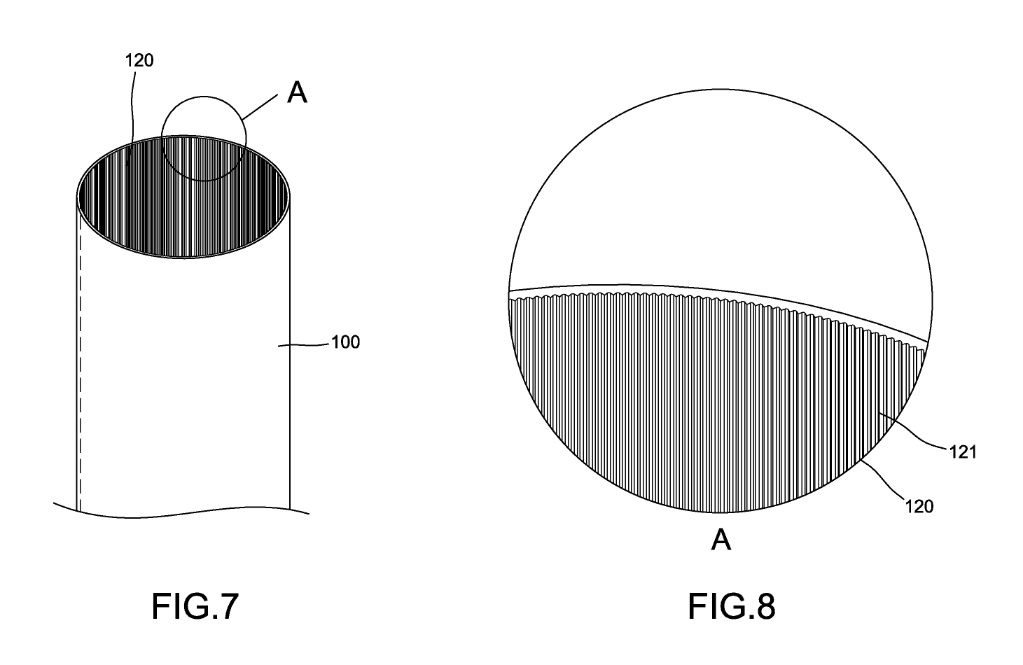

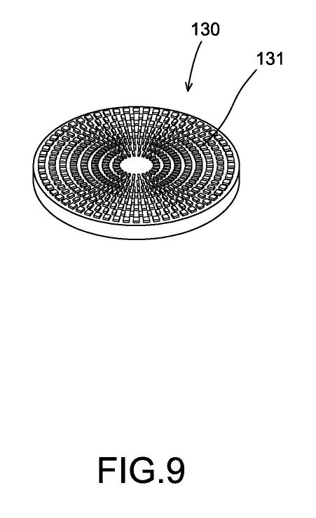

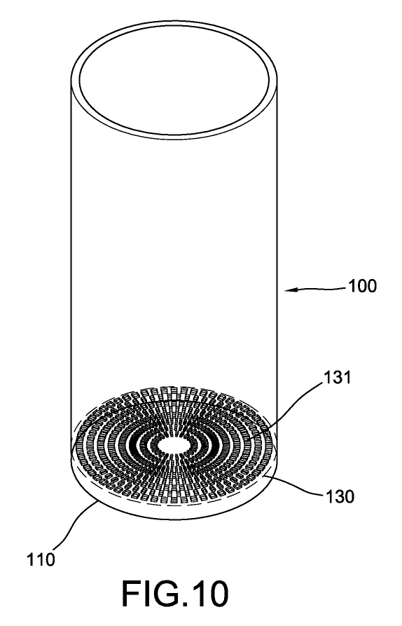

Step of forging: forging the section of the metal object 10 to be a hollow column 100. The hollow column 100, as shown in FIG. 6, has a flat bottom 110 and an open top. A guide surface 120 as shown in FIGS. 7 and 8 is formed in the inner periphery of the hollow column 100. The guide surface 120 of the hollow column 100 comprises multiple grooves 121 which extend longitudinally in the inner periphery of the hollow column 100 and from one end to the other end of the hollow column 100 so as to quickly circulate the liquid high heat transmission agent in the hollow column 100. The hollow column 100 has the flat bottom 110 which has a heat-exchange surface 130 as shown in FIGS. 9 and 10. The heat-exchange surface 130 of the bottom 110 comprises multiple bosses 131 extending therefrom and the bosses 131 are located radially and arranged in multiple circles. The diameter of the bottom 110 is 52 mm which meets the requirement of the area of high-watt Light Emitting Diode circuit board.

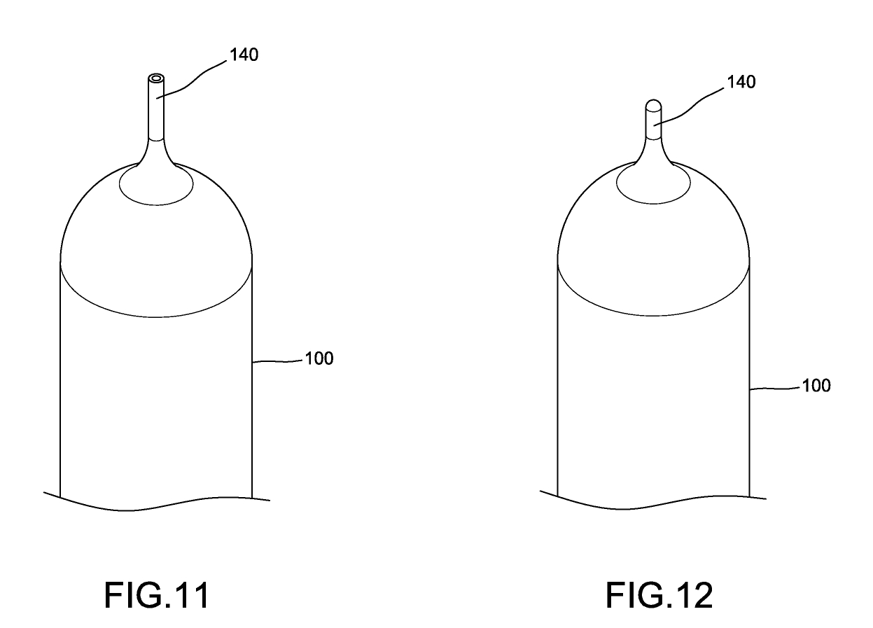

Step of necking: making a neck 140 on one end of the hollow column 100 as shown in FIG. 11. The neck 140 is made at a pre-set length according the practical need of the specification of the hollow column 100.

Step of sealing: sealing the neck 140. The interior of the hollow column 100 is sucked to be substantial vacuum status and a liquid high heat transmission agent is introduced into the interior of the hollow column 100. The neck 140 is then sealed by way of welding.

When the liquid high heat transmission agent is introduced into the interior of the hollow column 100 of the present invention, the bottom 110 is in contact with the heat source so that the liquid high heat transmission agent absorbs the heat from the heat source and is vaporized. The agent flows back when the hollow column 100 is cooled down, the heat from the heat source is quickly removed in the form of waves. The flat bottom 110 is fully in contact with the heat source so that the efficiency of removal of heat is high.

The flat bottom 110 of the hollow column 100 is formed integrally when the hollow column 100 is formed so that there is no extra work needed.

The guide surface 120 and the heat-exchange surface 130 of the hollow column 100 are formed integrally when the hollow column 100 is formed, no extra work needed.

The time that the liquid high heat transmission agent works is reduced because of the guide surface 120 so as to have a high efficiency of heat removing function.

The heat-exchange surface 130 makes the heat exchange more quick and efficient.

The hollow column 100 of the present invention only seals the neck 140 so that the manufacturing time is less than that of the conventional heat column which has to seal both ends.

Furthermore, compared with the method for making the conventional heat column, the present invention does not need two caps to seal both of the two ends of the heat column.

While we have shown and described the embodiment in accordance with the present invention, it should be clear to those skilled in the art that further embodiments may be made without departing from the scope of the present invention.

What is claimed is:

1. A method for making a heat column, comprising:
a step of preparing: preparing a section of a metal object which is cut from a metallic rod;
a step of forging: forging the section of the metal object to be a hollow column which has a flat bottom, a guide surface being formed in an inner periphery of the hollow column, the hollow column having a flat bottom which has a heat-exchange surface;
a step of necking: making a neck on one end of the hollow column, and
a step of sealing: sucking interior of the hollow column to be substantial vacuum status and introducing a liquid high heat transmission agent into the interior of the hollow column, the neck being sealed by way of welding.

2. The method as claimed in claim 1, wherein the guide surface of the hollow column comprises multiple grooves which extend from one end to the other end of the hollow column.

3. The method as claimed in claim 2, wherein the grooves extend longitudinally in the inner periphery of the hollow column.

4. The method as claimed in claim 1, wherein the heat-exchange surface of the bottom comprises multiple bosses extending therefrom.

5. The method as claimed in claim 4, wherein the bosses are located radially and arranged in multiple circles.
